(19) United States
(12) Patent Application Publication
(10) Pub. No.: US 2007/0262608 A1
(43) Pub. Date: Nov. 15, 2007

(54) Mounting structure of glass run

(75) Inventor: Katsushi Saito, Hiroshima-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Nishikawa Rubber Co., Ltd., Hiroshima-shi (JP)

(21) Appl. No.: 11/732,217

(22) Filed: Apr. 3, 2007

(30) Foreign Application Priority Data
May 12, 2006 (JP) JP2006-134502

(51) Int. Cl. B60J 5/00

(52) U.S. Cl. 296/146.7; 49/490.1

(57) ABSTRACT

There is provided a mounting structure of a glass run having a ditch part formed therein for guiding a door glass of an automobile and including: a cross-section roughly U-shaped installation base member consisting of an outer-cabin side wall, a bottom wall and an inner-cabin side wall; and an outer lip and an inner lip, which are respectively formed inward from the outer-cabin side wall and outward from the inner-cabin side wall of the installation base member and slidably brought into contact with the door glass, that a molding member covering the outer-cabin side wall from the outer-cabin side mounts said glass run to a door sash, wherein the molding member is integrally molded with a cross-section roughly U-shaped channel part having the installation base member of the glass run fitted therein.

### BACKGROUND OF THE INVENTION

The present invention relates to a mounting structure of a glass run which is mounted to a sash type door and guides lifting or lowering of a door glass.

An ordinary glass run 10 for guiding lifting or lowering of a door glass 200, shown in FIG. 9, has been mounted to a door sash 2 of an automobile door 100.

Examples of well-known mounting structures of the glass run 10 include those in FIG. 10 and FIG. 11 which are I-I line enlarged cross sections of FIG. 9 and that in FIG. 12 which is a II-II line enlarged cross section of FIG. 9.

The glass run 10 includes: a cross-section roughly U-shaped installation base member 11 consisting of an outer-cabin side wall 11a, a bottom wall 11b and an inner-cabin side wall 11c; an outer lip 12 formed inward from the outer-cabin side wall 11a of the installation base member 11; and an inner lip 13 formed outward from the inner-cabin side wall 11c of the installation base member 11. The installation base member 11 has a ditch part 20 formed therein for guiding the door glass 200, that is a space enclosed by the outer-cabin side wall 11a, the bottom wall 11b and the inner-cabin side wall 11c. The outer lip 12 and the inner lip 13 are slidably brought into contact with the door glass 200 lifting or lowering.

As shown in FIG. 10, an ordinary mounting structure of the glass run 10 including said members comprises: a cross-section roughly U-shaped channel part 30 constructed by assembling an exterior roof molding 31 (painted in black) on an end part of a cross-section roughly L-shaped part formed on an outer-cabin side of the door sash 2; and the glass run 10 mounted inside the channel part 30. On an outer-cabin side of the door 100, the roof molding 31 is assembled on a part 600 where an installation base member 3a of a drip seal 3, which makes an elastic contact with a body panel 300 when the door 100 is closed, is mounted. On the inner-cabin side of the door 100, a weather strip 4 is formed, which makes an elastic contact with the body panel 300 when the door 100 is closed.

In addition, as shown in FIG. 11 and FIG. 12, another example of well-known mounting structure comprises: a cross-section roughly U-shaped channel part 30 formed by bending the outer-cabin side of the door sash 2, thereby forming the channel part 30 only of the door sash 2; and the glass run 10 mounted inside the channel part 30. Such a structure is disclosed, for example, in the Japanese unexamined Patent Publication No. H10-329768.

However, the mounting structure of the glass run according to FIG. 10 discloses formation of the cross-section roughly U-shaped channel part 30 by assembly of two members: the door sash 2; and an exterior roof molding 31 assembled on the door sash 2. Therefore, there has remained a problem that the two members are inadequately assembled when one of the two members or both of the two members are uneven.

On the other hand, in the mounting structure of the glass run according to FIG. 11 and FIG. 12, unevenness which appears in the mounting structure of the glass run with the roof molding 31 according to FIG. 10 does not appear because the channel part 30 is formed only of the door sash 2.

However, in such a mounting structure, painting an external appearance exposing part 500 of the door sash 2 in another color such as black afterwards, if required, costs more because the door sash 2 and a door main body are unified so that the door 100 as a whole is painted in a solid color.

In addition, one of the ways of painting the external appearance exposing part 500 in another color afterwards is to adhere an extra tape of a desired color such as black on the external appearance exposing part 500 of the door sash 2 so as to prevent cling of paint stains which occurs in painting the external appearance exposing part 500 with the paint of another color afterwards on the door 100 main body where the painting is completed previously. However, the tape has brought about debasement in appearance caused by a gap or a wrinkle which appears in an adhesion operation or a partial exfoliation which appears later.

Therefore, an object of the present invention is to provide the mounting structure of the glass run capable of separating the molding part and excellent in assembling force.

### SUMMARY OF THE INVENTION

In order to achieve the above-mentioned object, the invention provides a mounting structure of a glass run (10) having a ditch part (20) formed therein for guiding a door glass (200) of an automobile and including: a cross-section roughly U-shaped installation base member (11) consisting of an outer-cabin side wall (11a), a bottom wall (11b) and an inner-cabin side wall (11c); and an outer lip (12) and an inner lip (13), which are respectively formed inward from the outer-cabin side wall (11a) and outward from the inner-cabin side wall (11c) of the installation base member (11) and slidably brought into contact with the door glass (200), that a molding member (40, 50) covering said outer-cabin side wall (11a) from the outer-cabin side mounts said glass run (10) to a door sash (2), wherein said molding member (40, 50) is integrally molded with a cross-section roughly U-shaped channel part (41, 51) having the installation base member (11) of said glass run (10) fitted therein.

In addition, an anchoring lip (14) may be provided on the inner-cabin side of the inner-cabin side wall (11c) of the glass run (10) while a concave part (43) may be formed between an inner-cabin side end part (42) of the molding member (40) and said door sash (2) so as to fit said anchoring lip (14) into the concave part (43).

Said molding member (40, 50) may be made of metal or resin.

A use of a molding member (50) made of resin enables integral molding of the molding member (50) with the glass run (10) or the integral molding of a grip (52) for installing the molding member (50) on a flange (400) formed on the door sash (2) with the inner-cabin side of the molding member (50).

Further, the grip (52) integrally molded with the molding member (50) may anchor to an installation base member (4a) of a weather strip (4) which is installed on the door sash (2) and makes an elastic contact with a body panel (300) when the door is closed.

Symbols in parentheses show constituents or items corresponding to Figures and DESCRIPTION OF PREFERRED EMBODIMENT.

According to the mounting structure of the glass run of the present invention, the glass run is mounted to the door sash by means of the molding member covering the outer-cabin side wall of the glass run from the outer-cabin side and the molding member is integrally molded with the cross-section roughly U-shaped channel part having the installation base member of said glass run fitted therein. Therefore, periphery of the glass run is covered with the molding member and the glass run is firmly assembled with the molding member. In addition, the channel part for assembling the glass run, formed only of the molding member (a glass run channel part) does not cause the unevenness described in BACKGROUND OF THE INVENTION (FIG. 10).

Further, the molding member can easily separate from the door sash. Therefore, the molding member can be painted, for example, on parts makers' end and the color painted on the molding member can be freely selected. As a result, painting the external appearance exposing part of the door sash in two colors or adhering the extra tape, described in BACKGROUND OF THE INVENTION (FIG. 11, FIG. 12) is unnecessary.

Still further, as the molding member is separable, the molding member can be provided as an assembly part having the glass run assembled therewith prior to an assembling line of an automobile.

Furthermore, assembling force of the glass run inside the molding member can be increased by fitting the anchoring lip provided on the inner-cabin side of the inner-cabin side wall of the glass run into the concave part formed between the inner-cabin side end part of the molding member and the door sash.

The use of a molding member made of metal which is excellent in rigidity and weatherability results in improved durability. In addition, luster peculiar to the metal demonstrates unique decorativeness.

On the other hand, the use of a molding member made of resin results in improved productivity as well as downsizing because the molding member made of resin can be set up the same color as the glass run so that further painting is not required.

In addition, integral molding of the molding member and the glass run results in further improved productivity because a process of assembling the molding member and the glass run becomes unnecessary.

Further, in the molding member made of resin, integral molding of the grip for installing the molding member on the flange formed on the door sash with the inner-cabin side of the molding member results in the improved productivity and the increased assembling force because producing and assembling the grip as an extra part become unnecessary.

Furthermore, anchoring the grip integrally molded with the molding member to the installation base member of the weather strip which is installed on the door sash and makes the elastic contact with the body panel when the door is closed results in the further increased assembling force.

### BRIEF DESCRIPTION OF THE DRAWINGS

FIG. 1 is a I-I line enlarged cross section of FIG. 9, showing a mounting structure of a glass run according to the first embodiment of the present invention;

FIG. 2 is a II-II line enlarged cross section of FIG. 9, showing the mounting structure of the glass run according to the first embodiment of the present invention;

FIG. 3 is a I-I line enlarged cross section of FIG. 9, showing another mounting structure of a glass run according to the first embodiment of the present invention;

FIG. 4 is a I-I line enlarged cross section of FIG. 9, showing another mounting structure of a glass run according to the first embodiment of the present invention;

FIG. 5 is a I-I line enlarged cross section of FIG. 9, showing a mounting structure of a glass run according to a second embodiment of the present invention;

FIG. 6 is an enlarged cross section of important portions of the mounting structure of the glass run of FIG. 5;

FIG. 7 is a II-II line enlarged cross section of FIG. 9, showing the mounting structure of the glass run according to the second embodiment of the present invention;

FIG. 8 is a I-I line enlarged cross section of FIG. 9, showing another mounting structure of a glass run according to the second embodiment of the present invention;

FIG. 9 is an outside lateral view showing an automobile door;

FIG. 10 a I-I line enlarged cross section of FIG. 9, showing a mounting structure of a glass run according to a prior art;

FIG. 11 is a I-I line enlarged cross section of FIG. 9, showing a mounting structure of a glass run according to another prior art; and

FIG. 12 is a II-II line enlarged cross section of FIG. 9, showing a mounting structure of a glass run according to another prior art.

### DESCRIPTION OF PREFERRED EMBODIMENT

### First Embodiment

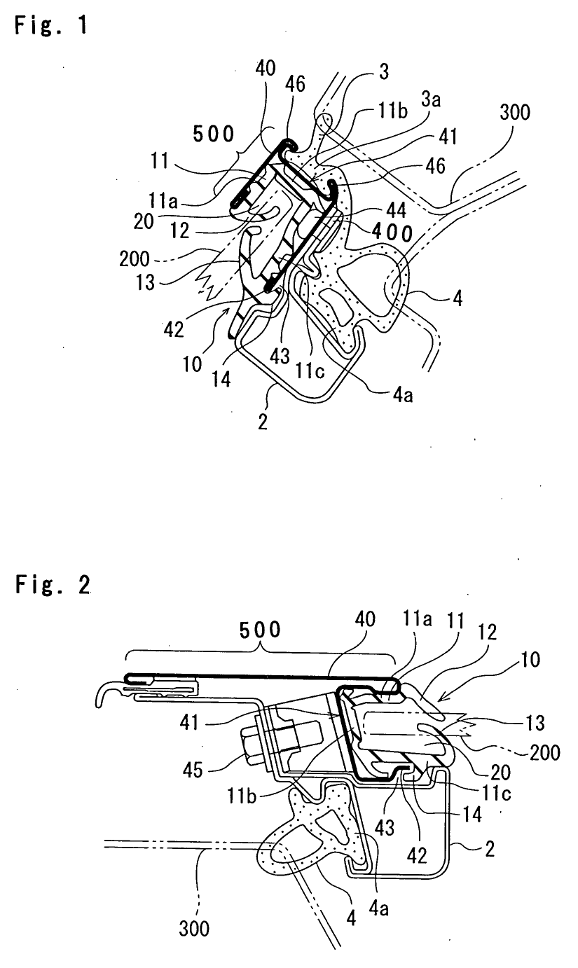

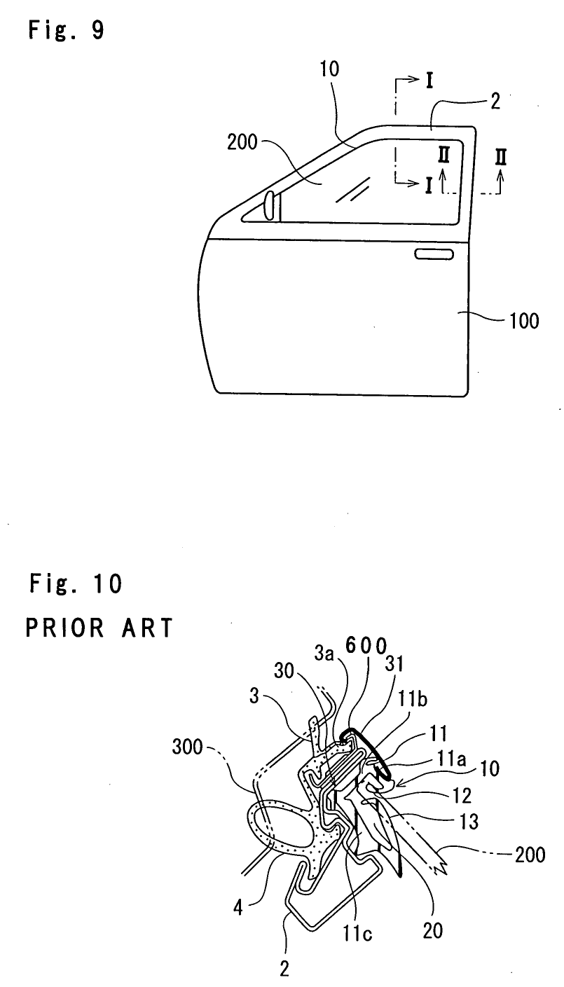

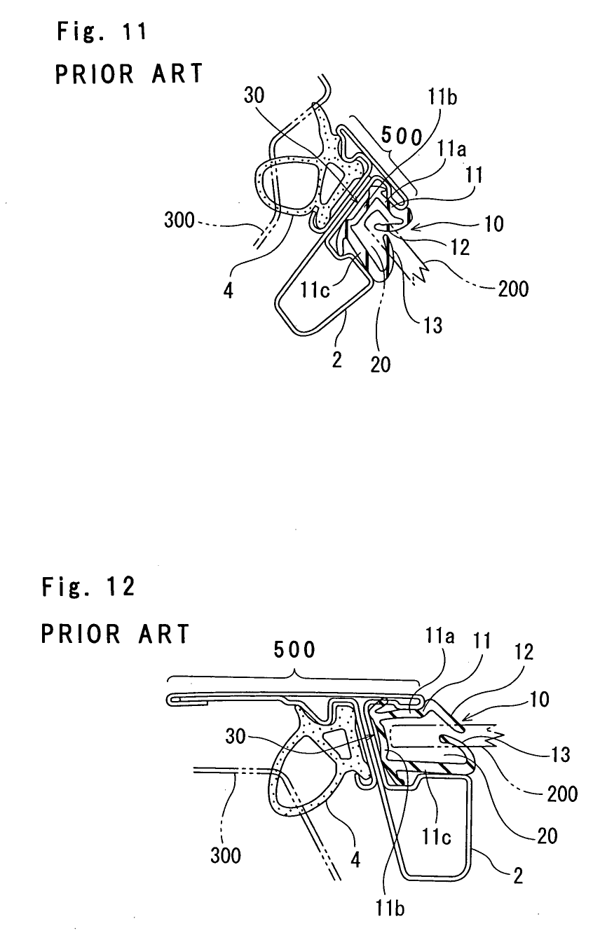

Referring to FIG. 1, FIG. 2 and FIG. 9, a mounting structure of a glass run according to a first embodiment of the present invention will be described. FIG. 1 is a I-I line enlarged cross section of FIG. 9, showing a mounting structure of a glass run according to the first embodiment of the present invention and FIG. 2 is a II-II line enlarged cross section of FIG. 9. When constituents or items correspond to those in prior arts, the same symbols are used.

The mounting structure of the glass run according to the first embodiment of the present invention is characterized in that a glass run 10 is mounted to a door sash 2 by means of a molding member 40 made of metal. The molding member 40 shown in FIG. 1 is a roof molding member whereas that shown in FIG. 2 is a pillar molding member. The molding members 40 shown in FIG. 1 and FIG. 2 are painted in black.

In the same manner as the prior arts, the glass run 10 guides lifting or lowering of a door glass 200 and includes: a cross-section roughly U-shaped installation base member 11 consisting of an outer-cabin side wall 11a, a bottom wall 11b and an inner-cabin side wall 11c; an outer lip 12 formed inward from the outer-cabin side wall 11a of the installation base member 11; and an inner lip 13 formed outward from the inner-cabin side wall 11c of the installation base member 11. A ditch part 20 which guides a door glass 200 is formed inside the installation base member 11, that is, a space enclosed by the outer-cabin side wall 11a, the bottom wall 11b and the inner-cabin side wall 11c. The outer lip 12 and the inner lip 13 are slidably brought into contact with the door glass 200 lifting or lowering.

The molding member 40 covers the outer-cabin side wall 11a of the glass run 10 from the outer-cabin side and an external appearance exposing part 500 which is the outer-cabin side of the molding member 40 is a decorative surface.

The molding member 40 is integrally molded with a cross-section roughly U-shaped channel part 41 having the installation base member 11 of the glass run 10 fitted therein. That is, the channel part 41 is a little larger than the cross-section roughly U-shaped installation base member 11 of the glass run 10 and has the glass run 10 assembled therein making use of elasticity of the glass run 10.

On a roof side of the molding member 40, as shown in FIG. 1, a cabin side of the molding member 40 is fixed to a flange 400 extending from the door sash 2 to an upper side by means of a caulking pin 44. On the other hand, on a pillar side of the molding member 40, as shown in FIG. 2, a bottom wall side of the channel part 41 of the molding member 40 is fixed to the door sash 2 by means of an attaching screw 45.

Assembling force of the glass run 10 inside the molding member 40 is increased by fitting an anchoring lip 14 provided on an outer side (the inner-cabin side) of the inner-cabin side wall 11c of the glass run 10 into a concave part 43 formed between an inner-cabin side end part 42 of the molding member 40 and the door sash 2. The concave part 43 may be formed by bending the door sash 2 to the inner-cabin side compared with the inner-cabin side end part 42 of the straight-lined molding member 40 as shown in FIG. 1 or by bending the inner-cabin side end part 42 of the molding member 40 to the outer-cabin side compared with the door sash 2 as shown in FIG. 2.

On the roof side, anchoring parts 46 are formed by bending the upper side of the molding member 40, that is, the upper side on a bottom wall side of the channel part 41. The anchoring parts 46 anchor to an installation base member 3a of a drip seal 3 which makes an elastic contact with a body panel 300 when the door is closed. An installation base member of a weather strip 4 is formed on the upper side of the door sash 2. The weather strip 4 makes the elastic contact with the body panel 300 when the door is closed. The drip seal 3 and the weather strip 4 are integrally molded.

In the above-mentioned mounting structure of the glass run, the molding member 40 is integrally molded with the cross-section roughly U-shaped channel part 41 having the installation base member 11 of the glass run 10 fitted therein. Therefore, periphery of the glass run 10 is covered with the molding member 40 and the glass run 10 is firmly assembled with the molding member 40.

In addition, the molding member 40 can easily separate from the door sash 2. Therefore, the molding member 40 can be painted, for example, on parts makers' end and colors painted on the molding member 40 can be freely selected. Further, as the molding member 40 is separable, the molding member 40 can be provided as an assembly part having the glass run 10 assembled therewith prior to an assembling line of an automobile.

Still further, the molding member 40 is made of metal excellent in rigidity and weatherability, which results in improved durability. In addition, luster peculiar to the metal demonstrates unique decorativeness.

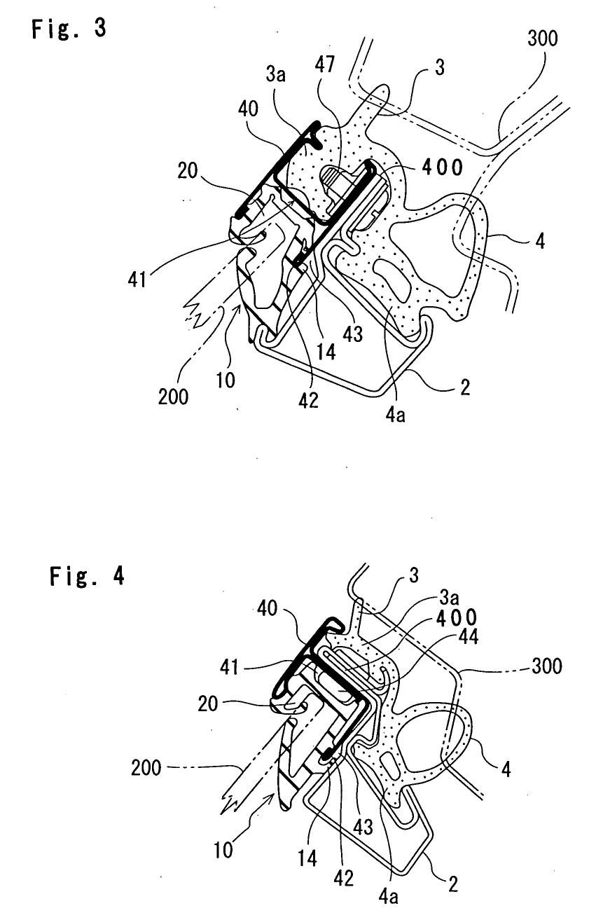

Although the present embodiment describes an example that the inner-cabin side of the channel part 41 formed on the molding member 40 was fixed to the flange 400 extending from the door sash 2 by means of the caulking pin 44 as shown in FIG. 1, the present invention is not limited to said embodiment. Modifications of said embodiment include: fixing a drip seal 3 side of the molding member 40 to the flange 400 extending from the door sash 2 by means of an attaching screw 47 as shown in FIG. 3; or fixing the bottom wall side of the channel part 41 of the molding member to the flange 400 which is extending from the door sash 2 and piled up on the upper side of said bottom wall side of the channel part 41 by means of the caulking pin 44 as shown in FIG. 4.

### Second Embodiment

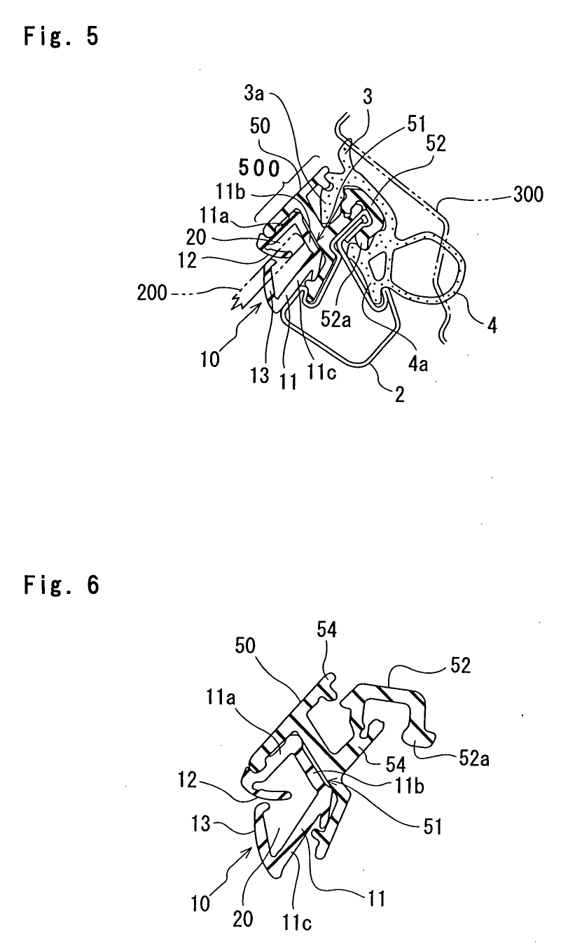

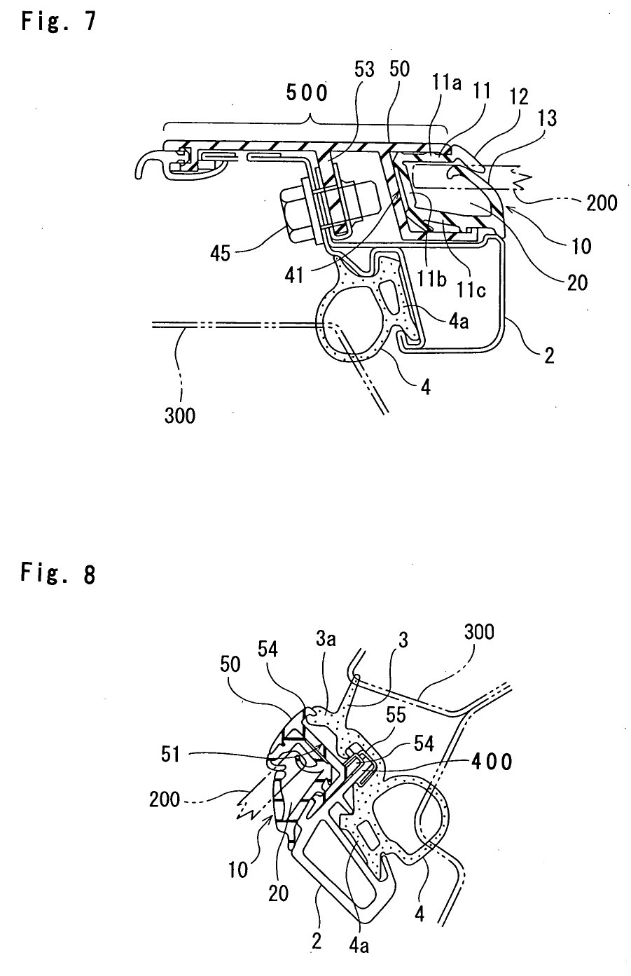

Referring to FIG. 5 to FIG. 7, a mounting structure of a glass run according to a second embodiment of the present invention will be described. FIG. 5 is a I-I line enlarged cross section of FIG. 9, showing a mounting structure of a glass run according to a second embodiment of the present invention and FIG. 7 is a II-II line enlarged cross section of FIG. 9. FIG. 6 is an enlarged cross section of important portions of the mounting structure of the glass run of FIG. 5. When constituents or items correspond to those in the prior arts, the same symbols are used.

The mounting structure of the glass run according to the second embodiment of the present invention is characterized in that the glass run 10 is mounted to the door sash 2 by means of a molding member 50 made of resin. The molding member 50 shown in FIG. 5 is a roof molding member whereas that shown in FIG. 7 is a pillar molding member.

The molding member 50 covers the outer-cabin side wall 11a of the glass run 10 from the outer-cabin side and the external appearance exposing part 500 which is the outer-cabin side of the molding member 50 is the decorative surface.

The molding member 50, in the same manner as the molding member 40 according to the first embodiment, is integrally molded with the cross-section roughly U-shaped channel part 51 having the installation base member 11 of the glass run 10 fitted therein. That is, the channel part 51 is a little larger than the cross-section roughly U-shaped installation base member 11 of the glass run 10 and has the glass run 10 assembled therein making use of the elasticity of the glass run 10.

On a roof side, as shown in FIG. 5 and FIG. 6, the molding member 50 is fixed to the flange 400 extending from the door sash 2 to the upper side by clasping the molding member 50 and the flange 400 by means of a cross-section roughly U-shaped grip 52 integrally molded with an upper cabin side of the molding member 50. The grip 52 has a projection 52a formed on an end thereof. A cabin side of the projection 52a anchors to an installation base member 4a of the weather strip 4 which is installed on the door sash 2 and makes an elastic contact with a body panel 300 when the door is closed. Such a structure causes pressuring force of the weather strip 4 to be transmitted from an outer-cabin side of the projection 52a of the grip 52 to the flange 400 on which the projection 52a abuts, thereby increasing assembling force of the grip 52 for clasping the molding member 50 and the flange 400.

On the other hand, on a pillar side of the molding member 50, as shown in FIG. 7, an elongated part 53 extending from the molding member 50 is fixed to the door sash 2 by means of the attaching screw 45.

On the roof side, anchoring parts 54 are formed on the upper side of the molding member 50, that is, an outer-cabin side and a cabin side on an upper side of a bottom wall of the channel part 51. The anchoring parts 54 anchor to the installation base member 3a of the drip seal 3 which makes the elastic contact with the body panes 300 when the door is closed. The drip seal 3 and the weather strip 4 are integrally molded.

In the above-mentioned mounting structure of the glass run, in the same manner as the first embodiment, the molding member 50 is integrally molded with the cross-section roughly U-shaped channel part 51 having the installation base member 11 of the glass run 10 fitted therein. Therefore, periphery of the glass run 10 is covered with the molding member 50 and the glass run 10 is firmly assembled with the molding member 50. In addition, the molding member 50 can easily separate from the door sash 2. Therefore, the molding member 50 can be painted, for example, on the parts makers' end and the colors painted on the molding member 50 can be freely selected. Further, as the molding member 50 is separable, the molding member 50 can be provided as the assembly part having the glass run 10 assembled therewith prior to the assembling line of the automobile.

Furthermore, in the second embodiment, since the molding member 50 is made of resin, the productivity is improved as well as the downsizing because the molding member 50 made of resin can be set up the same color as the glass run 10 so that further painting is not required.

Still further, the integral molding of the inner-cabin side of the molding member 50 with the grip 52 for installing the molding member 50 on the flange 400 formed on the door sash 2 results in the improved productivity and the increased assembling force because producing and assembling the grip 52 as an extra part becomes unnecessary.

Although the present embodiment shows the assembly of the molding member 50 and the glass run 10, which are respectively and separately formed, the molding member 50 and the glass run 10 may be integrally extrusion-molded.

Said structure results in further improved productivity because assembling the molding member 50 and the glass run 10 becomes unnecessary.

In addition, the molding member 50 may be installed on an aluminum door sash 2 by means of a metal clip 55 as shown in FIG. 8. Specifically, the anchoring part 54 formed on the upper cabin side of the molding member 50 is piled on the flange 400 extending from the door sash 2 to the upper side and the metal clip 55 fastens the anchoring part 54 and the flange 400. The use of the metal clip 55 has an advantage that preparation of a hole for mounting the clip on the molding member 50 is unnecessary.

Further, the molding member 40 and the molding member 50 may be made of synthesis of metal and resin.

1. A mounting structure of a glass run having a ditch part formed therein for guiding a door glass of an automobile and including: a cross-section roughly U-shaped installation base member comprising an outer-cabin side wall, a bottom wall and an inner-cabin side wall; and an outer lip and an inner lip, which are respectively formed inward from the outer-cabin side wall and outward from the inner-cabin side wall of the installation base member and slidably brought into contact with said door glass, and wherein a molding member covering said outer-cabin side wall from the outer-cabin side mounts said glass run to a door sash, wherein:
said molding member is integrally molded with a cross-section roughly U-shaped channel part having the installation base member of said glass run fitted therein.

2. The mounting structure of the glass run as claimed in claim 1, wherein:
an anchoring lip provided on a cabin side of the inner-cabin side wall of the glass run is fitted into a concave part formed between a cabin side end part of said molding member and the door sash.

3. The mounting structure of the glass run as claimed in claim 1, wherein:
said molding member is made of metal.

4. The mounting structure of the glass run as claimed in claim 1, wherein:
said molding member is made of resin.

5. The mounting structure of the glass run as claimed in claim 4, wherein:
said molding member is integrally molded with said glass run.

6. The mounting structure of the glass run as claimed in claim 5, wherein:
a grip for installing said molding member on a flange formed on the door sash is integrally molded with the inner-cabin side of said molding member.

7. The mounting structure of the glass run as claimed in claim 6, wherein:
the grip integrally molded with said molding member anchors to an installation base member of a weather strip, which is installed on said door sash and makes an elastic contact with a body panel when the door is closed.

8. The mounting structure of the glass run as claimed in claim 2, wherein:
said molding member is made of metal.

9. The mounting structure of the glass run as claimed in claim 2, wherein:
said molding member is made of resin.

10. The mounting structure of the glass run as claimed in claim 9, wherein:
said molding member is integrally molded with said glass run.

11. The mounting structure of the glass run as claimed in claim 10, wherein:
a grip for installing said molding member on a flange formed on the door sash is integrally molded with the inner-cabin side of said molding member.

12. The mounting structure of the glass run as claimed in claim 11, wherein:
the grip integrally molded with said molding member anchors to an installation base member of a weather strip, which is installed on said door sash and makes an elastic contact with a body panel when the door is closed.
